(19) United States
(12) Patent Application Publication
(10) Pub. No.: US 2003/0063185 A1
(43) Pub. Date: Apr. 3, 2003

(54) Three-dimensional imaging with complementary color filter arrays

(76) Inventor: Cynthia S. Bell, Chandler, AZ (US)

Correspondence Address: Timothy N. Trop, TROP, PRUNER & HU, P.C., STE 100, 8554 KATY FWY, HOUSTON, TX, 77024, US

(21) Appl. No.: 09/967,538

(22) Filed: Sep. 28, 2001

(51) Int. Cl. H04N 13/00

(52) U.S. Cl. 348/46; 348/42; 348/164; 382/167

(57) ABSTRACT

A cyan, magenta, and yellow array may be utilized with interspersed infrared detecting pixels to generate a three-dimensional depiction of an object with adequate green color sampling. Because the cyan and yellow pixels also detect green color information, adequate green spectral sampling may be achieved in a three-dimensional imaging device. In addition, sparsely incorporated infrared detecting pixels may be utilized to detect time-of-flight information. The time-of-flight data may be used to obtain depth information for generating stereoscopic or three-dimensional images.

### BACKGROUND

This invention relates generally to three-dimensional imaging and particularly to three-dimensional image capture.

With information about a third dimension, two-dimensional digital images can be used to develop three-dimensional representations of objects. For example, stereoscopic imaging systems take left and right image pairs and use those pairs in a way that enables the user to at least obtain the illusion of a three-dimensional depiction. In addition, information about the third or depth dimension can be utilized to generate a three-dimensional digital image of an object in some applications.

One problem with digital three-dimensional imaging systems is that it is generally desirable to capture an additional IR pixel. On conventional two-dimensional imaging systems, such as those using Bayer color filter arrays, two green pixels are captured for each red or blue pixel. The extra green pixel increases the sharpness of the captured image. Conventional three-dimensional imaging systems may utilize infrared detecting pixels to capture depth data. If infrared detecting pixels are intermeshed among the green, red and blue pixels to obtain depth information, the extra green information is conventionally replaced with an infrared capturing pixel. As a result, image sharpness suffers.

Thus, there is a need for a better way to enable digital imaging for three-dimensional imaging applications.

### BRIEF DESCRIPTION OF THE DRAWINGS

FIG. 1 is a schematic depiction of one embodiment of the present invention;

FIG. 2 is a pixel layout for one embodiment of the present invention;

FIG. 3 is a pixel layout in accordance with the prior art; and

FIG. 4 is a flow chart for software in accordance with one embodiment of the present invention.

### DETAILED DESCRIPTION

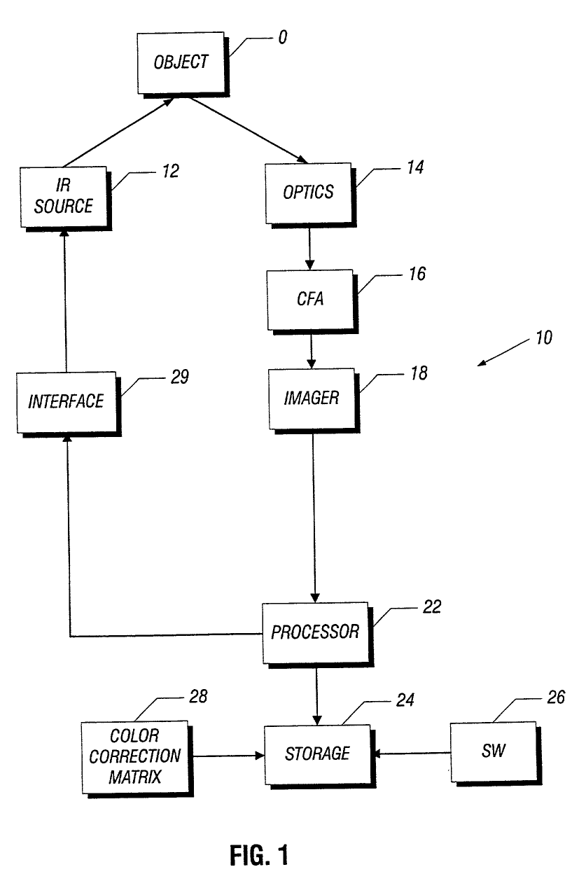

Referring to FIG. 1, a digital imaging device 10 may be a digital camera, a camcorder, a digital microscope or any other digital imaging system. The imaging device 10 may include an infrared source 12 that illuminates an object O with infrared light. An optic system 14 may include lenses or other structures to develop an appropriate image. A color filter array (CFA) 16 appropriately filters the incoming light to adapt for the imaging array that is utilized. A digital imaging array 18 may be in the form of a complementary metal oxide semiconductor (CMOS) imaging array or a charge coupled device (CCD) in accordance with some embodiments of the present invention.

The imaging array 18 develops an electronic output containing color and intensity information. In one embodiment, the imaging array 18 not only captures color and intensity information, but it may also capture infrared information. This infrared information may be useful for determining the depth of different objects in the imaging field. In one embodiment, the time-of-flight of the infrared radiation from the source 12 to the object 0 and back to the device 10 may be measured to determine how far away the object is in order. That distance information may be used to reconstruct a three-dimensional image from the two-dimensional color and intensity information.

The digital information from the array 18 may be provided to a processor 22 coupled to a storage 24. The storage 24 may store the software 26 together with a color correction matrix 28. In one embodiment of the present invention, a complementary cyan magenta yellow or CMY color space is utilized. Since many digital applications require red, green and blue color spaces (RGB), the color correction matrix 28 may be utilized to convert the CMY information to RGB information in accordance with one embodiment of the invention.

The processor 22 is also coupled to a triggering interface 29. The triggering interface 29 controls the infrared source 12 to develop infrared radiation pulses that may be reflected back by the object to determine depth information.

Turning to FIG. 2, a color filter array 16 in one embodiment, may include a Bayer pattern having a first row with yellow (Y) pixels 30 and magenta (M) pixels 32 alternating one after the other. A second row may include alternating cyan (C) pixels 34 and yellow (Y) pixels 30. The second row, in one embodiment, may also have an infrared (IR) detecting pixel 38. The infrared detecting pixels 38 may be sparsely dispersed throughout the filter 16. In one embodiment, two infrared detecting pixels 38 may be positioned in the fourth row. The fifth and sixth rows then repeat the pattern of the first and second rows and the seventh and eighth rows repeat the pattern from the third and fourth rows and so on. Thus, in one embodiment the ratio of color indicating pixels to infrared detecting pixels is less than about 25%. The proportion of infrared detecting pixels may vary for different applications, for example, depending on the nature of the depth information requirements for each application.

Cyan filters pass photons in both the green and blue spectral bands. Yellow filters pass photons in both the green and red spectral bands. Thus, by using the CMY complementary color space, at least two different pixels in each quad pattern (Y, M, C, Y) detect green light. The green sampling frequency of the array is important to reconstructing an adequately sharp image after digital signal processing. Conventional RGB arrays utilize two green detecting pixels. Through the use of the CMY color space, two green detecting pixels (the cyan and yellow pixels) may be incorporated in each quad pattern while still permitting sparse interpositioning of infrared detecting pixels 38.

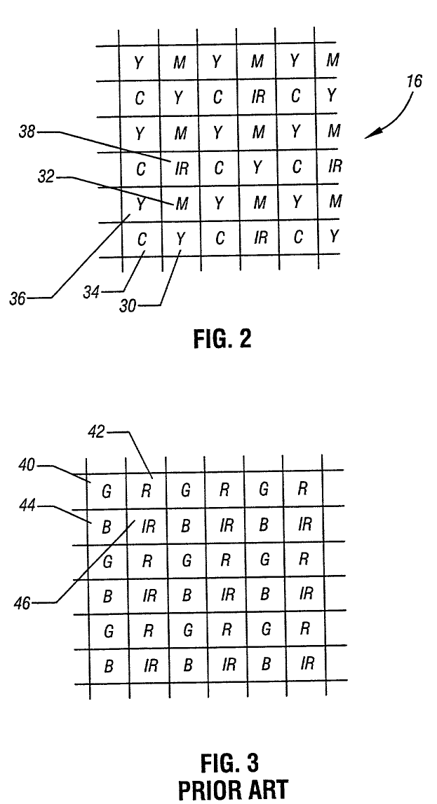

In contrast, with the prior art system shown in FIG. 3, alternating green and red filters are utilized in the first row 40 and alternating blue and infrared filters are utilized in the second row 44. This results in an inadequate amount of green color information to reconstruct an adequately sharp image after digital signal processing.

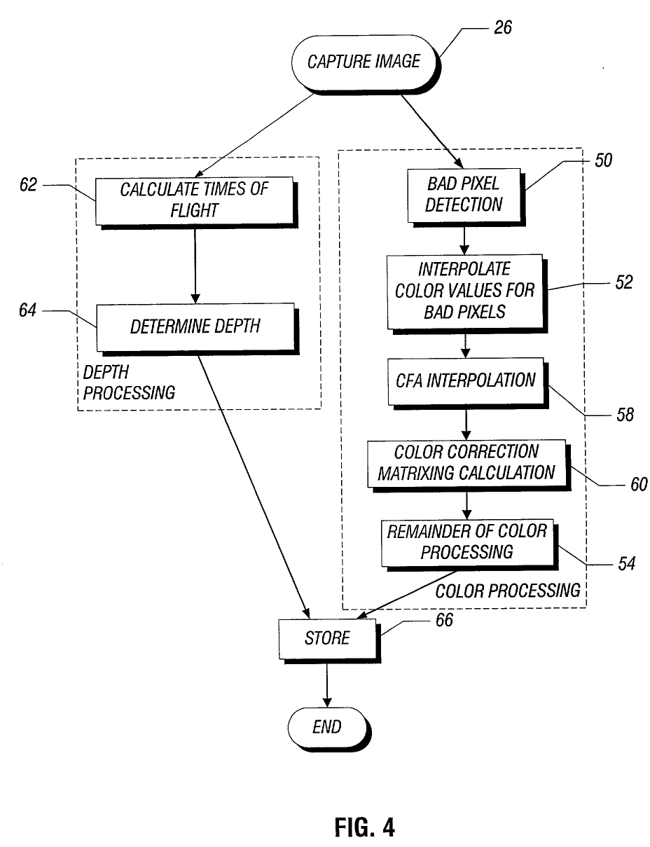

Turning to FIG. 4, another advantage of using sparse infrared detecting pixels is to allow correction with the conventional processing for color image reconstruction by automatically compensating for the absence of color information due to the presence of the infrared detecting pixels. In one embodiment, depth and color information may be processed in parallel paths in image capture software 26.

The color image processing of imager information flows conventionally beginning with bad pixel detection as indicated at block 50. Any pixels that are not producing signals with similarity to neighboring same-color pixels can be identified as bad pixels. Intensity values from neighboring pixels may be utilized to interpolate replacement values for bad pixels as indicated in block 52.

The infrared pixels 38 are detected as conventional bad yellow pixels and intensity information is interpolated to replace the missing information. In a parallel processing path, the infrared information may be utilized to determine time-of-flight information for the infrared pulses developed by the interface 29 and infrared source 12 under control from the processor 22.

Color filter array interpolation may then be accomplished conventionally, as indicated in block 58, followed by standard RGB conversion using the CMY color correction matrix as indicated in block 60. The color correction matrixing calculation may use the correction matrix 28 as indicated in block 60 to convert from the CMY color space to the RGB or any other desired color space. Thereafter, conventional color processing may be accomplished as indicated in block 54.

Turning next to the depth data processing, as indicated in block 62, the processor 22 enables the infrared source 12 to develop infrared pulses. The time for these pulses to be reflected and received back from the object 0 is determined for each IR pixel, as indicated in block 64. The depth information together, with the two-dimensional color and intensity information, may be stored as indicated in block 66 in some embodiments.

Thus, depth data for stereoscopic display and robust object recognition are possible with a single imager in some embodiments. Adequate sharpness of the resulting images after digital signal processing may be achieved by using a complementary Bayer color filter pattern and sparsely interspersed infrared detectors.

The frequency of the infrared pixels may be as shown in FIG. 2 in accordance with one embodiment of the present invention. However, the frequencies of the infrared detecting pixels may depend on how large an imaging array is utilized, the requirements of the application that utilizes the image and on other implementation details. It is desirable to have sufficient depth sampling to delineate object borders. However, it is desirable not to have so many infrared detecting pixels 38 that the image quality suffers substantially.

In some embodiments, the depth information may be used for adaptive compression, object recognition, or three-dimensional stereoscopic display, as a few examples.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
capturing an image of an object using an imaging device including cyan, magenta, yellow and infrared detecting pixels; and
developing three-dimensional information about the object.

2. The method of claim 1 including directing an infrared beam at said object.

3. The method of claim 2 including determining the distance from said object by analyzing the time-of-flight of said beam to and from said object.

4. The method of claim 1 including compensating for defective pixels.

5. The method of claim 4 including compensating for the infrared detecting pixels as though the infrared detecting pixels were defective pixels.

6. The method of claim 5 including compensating for said infrared detecting pixels by interpolating color values from surrounding pixels.

7. The method of claim 1 including converting from the cyan, magenta, yellow color space to the red, green, blue color space.

8. The method of claim 1 including using a filter that filters for cyan, magenta and yellow light.

9. The method of claim 1 including capturing an image using approximately two yellow detecting pixels for every one cyan and magenta detecting pixel.

10. The method of claim 1 including using less than 25% infrared detecting pixels.

11. A device comprising:
an imager that captures an image of an object using cyan, magenta, yellow and infrared detecting pixels; and
a processor coupled to said imager to develop three-dimensional information about the object.

12. The device of claim 11 including a color filter array that filters for cyan, magenta and yellow.

13. The device of claim 11 including a infrared radiation source.

14. The device of claim 11 wherein said processor determines the distance of said device from said object by analyzing the time of flight of said beam to and from said object.

15. The device of claim 11 including a storage storing a color correction matrix to convert cyan, magenta and yellow information to red, green and blue information.

16. The device of claim 11 wherein said processor detects and compensates for defective pixels.

17. The device of claim 15 wherein said processor compensates for the infrared detecting pixels as though the infrared detecting pixels were defective pixels.

18. The device of claim 16 wherein said processor compensates for infrared detecting pixels by interpolating color values from surrounding pixels.

19. The device of claim 11 wherein said imager includes approximately two yellow detecting pixels for every one cyan detecting pixel.

20. The device of claim 11 wherein said imager uses less than 25% infrared detecting pixels.

21. A device comprising:
an imager;
a color filter array that filters for cyan, magenta, yellow and infrared;
an infrared source; and
a processor coupled to said imager to develop a three-dimensional information about an object.

22. The device of claim 21 wherein said processor determines the distance of said device from said object by analyzing the time of flight of said infrared beam to and from said object.

23. The device of claim 21 including a storage storing a color correction matrix to convert cyan, magenta and yellow information to red, green and blue information.

24. The device of claim 21 wherein said processor compensates for defective pixels.

25. The device of claim 24 wherein said processor compensates for the infrared detecting pixels as though the infrared detecting pixels were defective pixels.
